(19) United States
(12) Patent Application Publication
(10) Pub. No.: US 2025/0284680 A1
(43) Pub. Date: Sep. 11, 2025

(54) MULTI-VECTOR SEARCH

(71) Applicant: Oracle International Corporation, Redwood Shores, CA (US)

(72) Inventors: Rohan Aggarwal, Menlo Park, CA (US); Aurosish Mishra, Foster City, CA (US); Agnivo Saha, Belmont, CA (US); Angela Amor, Menlo Park, CA (US); Shasank Kisan Chavan, Menlo Park, CA (US); Tirthankar Lahiri, Palo Alto, CA (US)

(21) Appl. No.: 19/075,706

(22) Filed: Mar. 10, 2025

Related U.S. Application Data
(60) Provisional application No. 63/563,926, filed on Mar. 11, 2024.

(51) Int. Cl. G06F 16/22

(52) U.S. Cl. CPC G06F 16/2237; G06F 16/2264

(57) ABSTRACT

A plurality of item-chunk queues, an item map, and an item results queue are maintained. A plurality of vectors are identified, each vector corresponding to a different chunk of a plurality of chunks. For each vector of the plurality of vectors: an item identifier of the each vector is identified; an item-chunk queue that corresponds to the item identifier is identified; and a determination is made as to whether the each vector is to be added to the item-chunk queue. A particular item identifier is stored in an entry, of the item map, that references a particular item-chunk queue of the plurality of item-chunk queues. A determination is made as to whether to add the at least one vector to the particular item-chunk queue. A determination is made as to whether to update the item results queue based on the at least one vector.

### BENEFIT CLAIM

This application claims the benefit of provisional application 63/563,926, filed Mar. 11, 2024, the entire contents of which is hereby incorporated by reference.

### FIELD

The present invention relates to queries for data in a database and, more specifically, to performing multi-vector searches.

### BACKGROUND

A vector is a fixed-length sequence of numbers, typically floating-point numbers, such as [21.4, 45.2, 675.34, 19.4, 83.24], which is a five-dimensional vector. An embedding is a means of representing objects (e.g., text, images, and audio) as points in a continuous vector space where the locations of those points in space are semantically meaningful to one or more machine learning (ML) techniques. An embedding is often represented as a vector. Generically, a vector embedding represents a point in N-dimensional space. Vector embeddings are intended to capture the important “features” of the data that the vector embeddings represent (or embed). The data a vector embedding represents can be one of many types of data, such as a document, an email, an image, or a video. Examples of features are color, size, category, location, texture, meaning, and concept. Each feature is represented by one or more numbers (dimensions) in the vector embedding. Hereinafter, a “vector embedding” is referred to as a “vector.”

### Distance Between Vectors

An important attribute of vectors is that the distance between two vectors is a good proxy for the similarity of the objects represented by the vectors. Two vectors that represent similar data should be a short distance from each other in vector space. The opposite is also true: dissimilar data are represented by vectors that are far apart from each other in the vector space. For example, the distance between a vector for the word “cat” and a vector for the word “dog” should be less than the distance between the vector for the word “cat” and a vector for the word “plant.”

The distance between two vectors is often calculated by summing the squares of the difference between the numbers in each position of the vectors:

(Vector1[1]−Vector2[1])\hat{ }2+(Vector1[2]−Vector2[2])\hat{ }2+ . . .

The property that vector distance represents object similarity is what allows similar data to be found using a vector database. For example, when a vector representing a picture of a dog is searched for in a vector database, the nearest vectors will be those representing other dogs, not vectors representing plants.

### Vector Processing Workloads

Vector processing workloads (not to be confused with single instruction, multiple data (SIMD) vector processing) have been used in Natural Language Processing (NLP), image recognition, recommendations, etc. Vector processing workloads have two sub-categories that require separate optimization strategies: indexing and searching. Regarding indexing, vector embeddings (or simply vectors) are indexed using approximate indexing techniques. Unlike B-tree indexes, a vector index returns many matching values ranked by similarity. Index creation and rebuild tend to be Central Processing Unit (CPU) intensive and are optimized for throughput.

Regarding searching, the stored vectors are searched using a class of algorithms known as “Similarity Search” or “Approximate Nearest Neighbor (ANN)” to find the closest vectors to a query vector. A search is designed to minimize CPU usage in order to minimize response time.

### Vector Processing Patterns

A vector similarity search is like interactive online transaction processing (OLTP) in that end-users submit vector queries and expect an instant reply. Vector similarity search requires millisecond response times to find vectors that are close (represent similar data) even when the database in which the vectors are stored holds billions of vectors. An example query is “find products that are similar to this picture [reference to a digital image].” Another example query is “find corporate documents that conceptually match this natural language prompt: [NL prompt].”

Providing fast response times requires using specialized vector indexes and fast algorithms for computing distances between vectors. In some use cases, there is a need to combine vector similarity search with relational data. For example, a query may ask for data about houses that match a natural language prompt, are valued at over $1M, are in zip code 94070, and whose owner recently declared bankruptcy. Also, there may be a need to be able to insert new vectors into a database, delete vectors from the database, and index the vectors in real time.

### Vector Databases

Early vector workloads often used flat files or object stores to store vectors. An application would read the vectors out of their backend repositories into memory and perform vector processing using third-party libraries, such as Facebook® artificial intelligence (AI) similarity search (FAISS). Generative AI has greatly increased the volume and processing needs for vectors. Generative AI requires support for much higher volume ingest and faster filtering and retrieval. A database with vector capabilities and built-in indexing is important for these applications.

### Hierarchical Navigable Small Worlds Elements

An in-memory neighbor graph vector index of the type Hierarchical Navigable Small Worlds (HNSW) includes various elements. An HNSW index can also be referred to as an HNSW graph. One HNSW index element is an in-memory vector vertex map that tracks all the vectors that are indexed, as well as the row identifiers (IDs) in a base table corresponding to those vectors.

Another HNSW index element is a layer-wise in-memory graph that keeps track of the neighborhood for all vertices. There are multiple layers in the HNSW graph, where the lowest layer contains all vectors and each higher layer contains fewer vectors than the layer below, where the number of vectors can decay exponentially in higher layers. Each layer has a layer vertex ID to neighbor map that maps a vector in a particular layer, Layer (i), to all its neighbor vertices in Layer (i), where “i” identifies the particular layer. Every layer potentially has different vertex IDs. Each layer also has a layer-to-layer vertex ID map that maps a vector's vertex ID from Layer (i) to the vertex ID at Layer (i−1). For example, only some vertices may be nominated to go to a higher layer, and the layer-to-layer vertex ID map maps the vertices in a given layer to the lower layer map for fast navigation. Each layer further has a layer vertex ID to a global vector ID pointer map that maps a local vertex ID to the ID of the vector that is present in the global vector storage.

Another HNSW element is a row ID to vertex ID (also described as VID) map, which is a table that tracks a mapping between physical row IDs for the base table vectors and the logical vertex IDs in the HNSW index. The row ID to VID mapping can improve pre-filtering performance.

Another element is a deleted vectors list that tracks the set of vertices that have been deleted from the base table but still have a presence in the HNSW index. The deleted vectors list can be a bitmap, can be a table, or can be otherwise stored in memory.

### Multi-Vector Searches

Multi-vectors describe scenarios in which a single entity or object has multiple vectors. Examples of entities can be text documents, people, businesses, audio recordings, videos, and other entities. Text documents can be chunked into pages, paragraphs, sentences, and words, which can be considered chunks with hierarchical attributes. In a hierarchy of attributes, there are multiple values of a lower-level attribute for each value of a higher-level attribute, such as multiple words per sentence. In another example, an entity representing a person can be chunked into multiple different photos. Each chunk of entity data can be embedded into a different vector, where the vectors conceptually represent the entity. When searching for an entity, candidate entities are matched based on the closest chunk vector within the entity to a given query vector.

For example, when a user performs a search using a search engine, a document on a website can include many relevant paragraphs. A vector search for a user query can match some of the paragraphs in one document on one website and another document on another website. The user may not want to see all matching paragraphs from a single document in their top results. Instead, the user may only want to see a specified number of paragraphs per document in the top documents.

Searching for entities that are chunked into multiple vectors is a complex process that requires excessive processing power and memory storage. For example, prior searches used an exploration heap and a results heap that both stored entities. These heaps did not provide an efficient technique for searching for top entities using chunks because the exploration heap and the results heap only store the entities without consideration of the chunks. If the chunks were implemented, the results heap would be more complicated because it may need to store not only the documents but also the corresponding document chunks, each of which has a different distance from a query vector. Traditional data structures are cumbersome in terms of processor and memory efficiency due to the complexity of maintaining and discarding the top documents, the closest chunk vectors, and the corresponding distances of the chunk vectors of each document in a results heap during a multi-vector search.

The approaches described in this section are approaches that could be pursued, but not necessarily approaches that have been previously conceived or pursued. Therefore, unless otherwise indicated, it should not be assumed that any of the approaches described in this section qualify as background merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In order to describe the manner in which advantages and features of the disclosure can be obtained, a description of the disclosure is rendered by reference to specific embodiments thereof which are illustrated in the appended drawings. These drawings depict only example embodiments of the disclosure and are not therefore to be considered to be limiting of its scope. The drawings may have been simplified for clarity and are not necessarily drawn to scale.

FIG. 1 is a block diagram that depicts an example Database Management System (DBMS) according to an example embodiment.

FIG. 2 is an illustration of a multi-vector query on document chunks according to an example embodiment.

FIG. 3 is an illustration of a multi-vector query syntax according to an example embodiment.

FIG. 4 is an illustration of a query using joins with multi-vector grouping according to an example embodiment.

FIG. 5 is a diagram that depicts an example logical representation of an HNSW index having four layers according to an example embodiment.

FIGS. 6A through 6I are example illustrations of a process of multi-vector searching according to an example embodiment.

FIG. 7 is a flowchart of a method for multi-vector queries according to an example embodiment.

FIG. 8 is a block diagram that illustrates a computer system upon which aspects of the illustrative embodiments may be implemented.

FIG. 9 is a block diagram of a basic software system that may be employed for controlling the operation of a computer system to implement aspects of the illustrative embodiments.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

As discussed above, a multi-vector search is a search for multiple vectors when an entity has been broken up into chunk vectors. Chunks can be strict subsets of an entity, such as audio clips of a full recording, video clips of an episode of a show, pictures of a person, songs by an artist, paragraphs of a document, departments of a business, and other chunks. In other words, chunks are sub-items of an item. A multi-vector search occurs when a query requests a number of top entities and a number of chunks for each top entity.

When performing a search of an HNSW index that includes neighborhoods of vertices, two heaps are traditionally maintained: an exploration heap, such as a candidates heap, and a results heap, such as a topK heap used to find the topK elements in a dataset, where topK can also be referred to as “top-K”, “top K”, “TopK”, and other variations. The exploration heap is for exploring the HNSW index. The exploration heap is a type of priority queue that tracks which neighborhoods and nodes to explore. It is a min heap that tracks the vertices with the shortest distance to a query vector.

According to a possible embodiment, multiple data structures are used to perform a multi-vector search. The data structures include a chunk candidates heap, a chunks heap for each entity, an entity hash table, and an entity results heap. The chunk candidates heap tracks the chunk vertices that are explored. When a chunk vertex is popped out of the heap for comparison to chunks in a corresponding entity chunks heap, neighbor vertices of a chunk vertex are added to the chunk candidates heap. The entity hash table can be an entity hash map that maps entities to respective entity chunk heaps. The entity chunks heaps include the top chunks for each respective entity. The entity results heap includes the result entities of the search and can include information, such as the distance of the closest found chunk of the entity to a search vector. The entity results heap can be an intermediate results heap that acquires a certain number of entities greater than the desired number of top entities. The desired number of top entities are taken from the intermediate results heap and placed in a final results heap.

In some embodiments the data structures are more complex than previous data structures. For example, a previous results heap was a heap where the same element did not exist twice and the elements in the results heap did not change aside from when they were popped out of the heap. In some embodiments, elements in the results heap can change, such as by changing information about the distance of a closet explored chunk vector from a query vector.

### Multi-Vector Documents Search

Documents will be used as example entities for descriptive purposes, but embodiments can be used for any entity. Also, references are made to chunks and documents. Such references relate to chunk IDs, document IDs, and other related information. For example, the description of the addition of a chunk to a chunk heap can imply an entry is added to the chunk heap for the corresponding chunk, where a chunk ID and/or other information corresponding to the chunk and/or the vector of the chunk is added to the chunk heap.

A query can request the two most relevant documents and the two most relevant chunks, such as paragraphs, of the most relevant documents. Multiple chunk vectors, such as vectors for paragraphs, are searched based on their distance from the query vector to return the relevant documents and paragraphs. The query can specify a chunks_per_document value, where only documents for which utmost or at least a chunks_per_document number of chunks have been explored by the HNSW search are allowed to be part of the document results heap.

A document hash table that maps each document to its respective chunk heap. The chunks heaps include heaps for each document. Each chunk heap tracks the current top chunks_per_document chunks for the respective document. The document results heap is a max heap that tracks a current top number of documents along with the respective distance of their minimum found chunk distance from the query vector.

Chunks are popped from the exploration heap until the search finishes by obtaining a threshold number of entities in the document results heap, which can be an intermediate results heap, as discussed above. The document hash table is maintained to map the documents to their respective chunk heaps. During the search, candidate chunks of documents are added to the corresponding document chunk heaps. If there is a threshold number of chunks in its corresponding chunk heap, the candidate chunk is compared to a chunk with the highest distance in a chunk heap for the document to determine if it is closer to the query vector. If the candidate chunk is closer to the query vector, the chunk with the highest distance in the heap is replaced with the candidate chunk.

Documents are added to the document heap with a value for their closest chunk distance from the query vector. If an entry for a document already exists in the document heap when a chunk for the document is found with a closer distance, the document's chunk distance value is updated with the closer distance. For example, a document may exist in the results heap, where the closest chunk of that document to a query vector has a certain distance from the query vector. A new chunk for the existing document may be found with a closer distance to the query vector and the distance information of the existing document can be updated with the closer distance.

If the number of documents in the document heap has reached a threshold, the minimum distance in the corresponding document chunk heap is compared to the minimum distance of documents in the document heap. If the minimum distance of the document chunk heap is less than an existing document, the document in the document heap is replaced with the document with the lower distance. The search continues until the threshold number of documents are in the document heap and no more chunks are found for documents to replace the existing documents or document distances in the document heap.

According to another related embodiment, a vector query that includes a query vector is received. A plurality of item-chunk queues, an item map, and an item results queue are maintained. (A document is an example of an item.) A plurality of vectors are identified, each vector corresponding to a different chunk of a plurality of chunks. For each vector of the plurality of vectors: an item identifier of said each vector is identified; an item-chunk queue that corresponds to the item identifier is identified; and a determination is made as to whether said each vector is to be added to the item-chunk queue. A particular item ID is stored in an entry, of the item map, that references a particular item-chunk queue of the plurality of item-chunk queues. A determination is made as to whether to add the at least one vector to the particular item-chunk queue that corresponds to the particular item ID. A determination is made as to whether to update the item results queue based on the at least one vector.

### Covering Columns

A covering column can be included in an index to ensure that the index can satisfy a query without needing to access the base table itself. For example, an HNSW source array can be indexed by a vertex ID (VID), which is an offset and points to a vector element that contains a row ID, the vector payload, and a covering column pointer. The covering column pointer points to a covering column payload for the particular VID. The covering column payload can include information, such as the document ID, which can allow the identification of the document ID for a chunk without referencing the base table.

The covering column pointer can be stored in a segment. Each segment can have a row major or column major format. Row major format can be useful for fast access. Column major format can be useful for row movement and compression. Covering columns can be used for a multi-vector search but are not necessary because the information can be obtained from the base table.

### Efsearch

A parameter, efsearch, can be used to indicate how many results are desired in the results heap. It can be set higher than a number of results requested in a query to allow the search to perform additional exploration. For example, if a query requests two results, and efsearch is set to three, the search will not stop until three results are in the results heap and no other candidates can beat the results. Then, the top two results are returned for the query. In some interpretations, the term “efsearch” can be considered an exploration factor search, but the term may not be limited to this interpretation. It is noted that efsearch will be greater than the number of results requested by the query.

As a further example of a vector search using only an exploration heap and a results heap, a query can be for the single closest chunk vector to a query vector, and efsearch can be set to two. Thus, the results heap would be limited to up to two vectors, even if only one result is desired. During the search, candidate vectors are placed into the exploration heap. The minimum vector, the vector with the closest distance to the query vector, in the exploration heap is popped, such as taken, from the exploration heap. The neighbor vectors of the minimum vector are then placed in the exploration heap with the next closest vector on top. The minimum vector is evaluated and put into the results heap if it qualifies for entry. When the results heap has efsearch=2 vectors, any candidate vectors must beat a vector in the results heap for addition, where the vector with the largest distance in the results heap is then removed to maintain efsearch=2 vectors in the results heap. The search stops after efsearch=2 vectors are in the results heap and no vectors in the exploration heap beat the vectors in the results heap. Only the desired single result vector is returned in response to the query, but the additional vector from the efsearch=2 allows additional exploration of the HNSW graph.

Thus, the exploration heap tracks the frontier of vector exploration. The results heap tracks the running best candidates up to the efsearch number of candidates. The best vector in the exploration heap is judged against vectors in the results heap to determine if the best vector in the exploration heap can beat the worst vector in the results heap. If so, the worst vector in the results heap is replaced by the best vector in the exploration heap and exploration is continued. At a point, the best vector in the exploration heap cannot beat the worst vector in the results heap and the search stops if the number of candidates in the results heap has reached efsearch. The top desired number of vectors are then returned from the results heap. The use of efsearch increases the number of explored vectors, which increases the odds of finding explored vertices that beat existing results vertices.

### Example Outcomes

Prior to the use of chunks, searches were performed on entities and a corresponding exploration heap and a results heap returned entities. When an entity is broken into chunks and a search is performed on chunks, then the exploration heap and the results heap would include chunks, even if the desired results are for entities. In embodiments directed to a multi-vector search, the exploration heap contains chunks, and the results heap contains entities. For example, the exploration heap contains chunks of a document, and the results heap contains the documents. Embodiments improve processor and memory efficiency by efficiently maintaining and discarding top documents, closest chunk vectors, and corresponding distances of the chunk vectors of each document during a multi-vector search. These embodiments improve database performance by allowing more efficient organization of search results, and streamline the search process, which saves both processing power and memory space.

As discussed above, when a user performs a search using a search engine, a document on a website can include many relevant paragraphs. A vector search for a user query can match some of the paragraphs in one document on one website and another document on another website. The user may not want to see all matching paragraphs from a single document in their top results. Instead, the user may only want to see a specified number of paragraphs per document in the top documents. For example, the user may just want to retrieve documents and focus on the top paragraphs per document. Embodiments directed to multi-vector searching focus the search results on the documents, instead of chunks, despite searching vectors for chunks.

### Database Management System

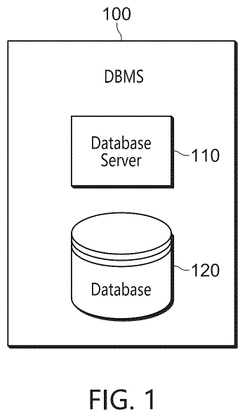

FIG. 1 is a block diagram that depicts an example DBMS 100 according to an example embodiment. DBMS 100 includes a database server 110 and a database 120. The database server 110 is communicatively coupled to the database 120. DBMS 100 may be deployed in a network of an enterprise or may be deployed in a cloud environment and, therefore, may be accessible to an enterprise over one or more computer networks (e.g., the Internet). DBMS 100 may be provisioned for an enterprise by a cloud management team of a cloud provider as needed on an enterprise-by-enterprise basis.

Database server 110 includes one or more computing machines, each executing one or more compute instances that receive and process data requests, including data retrieval requests (e.g., queries) and data modification requests. A computing instance translates a data request into a storage layer request that the computing instance transmits to the database 120. A computing machine that hosts at least one compute instance includes (1) one or more processors, (2) volatile memory for storing data requests (and their respective contents) and data that is retrieved from the database 120, and (3) optionally, non-volatile memory.

The database 120 may comprise multiple storage devices, each storing data. For example, database 120 stores a table that includes one or more columns for storing user data, such as a column for storing a user identifier, a column for storing a user profile, a column for storing user search history, a column for storing user access history, a column for storing user-generated content, etc. In this example, each row in the table corresponds to a user, such as a customer, a subscriber to a service, etc.

### Multi-Vector Queries

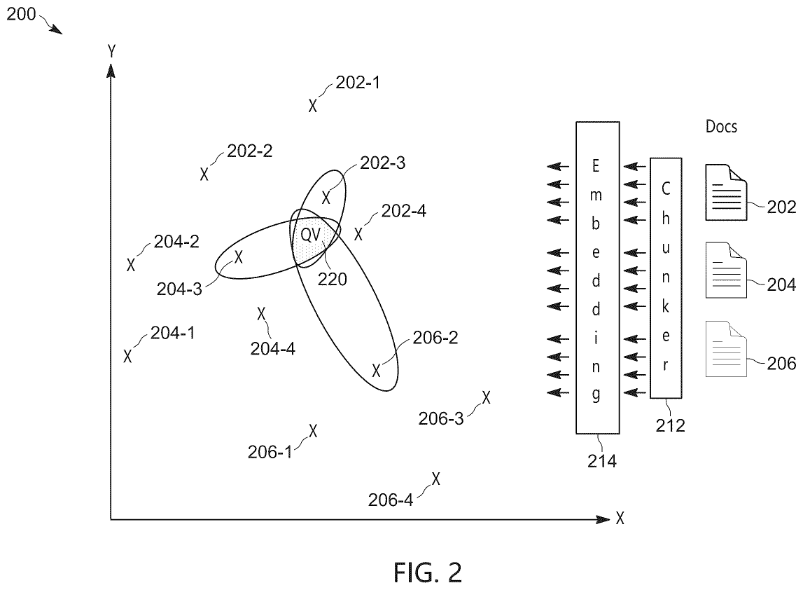

FIG. 2 is an illustration 200 of a multi-vector query on document chunks according to an example embodiment. Multi-vector describes a scenario in which multiple vectors correspond to a single entity. For example, text documents can be chunked into paragraphs, sentences, words, etc. Each chunk can be embedded into a vector. Documents are matched based on the closest chunk within the document to a given query vector.

For example, documents 202, 204, and 206 are entities that are fed into a chunker 212. The chunker 212 breaks the documents into four chunks each, where each chunk represents a paragraph in this example. An embedder 214 embeds each of the chunks into respective vectors 202-1 through 202-4, 204-1 through 204-4, and 206-1 through 206-4. A user's search term for the documents is embedded in query vector 220. Vectors 202-3, 204-3, and 206-2 are the closest chunk vectors to the query vector 220 across all three documents. The chunk vector 202-4 is closer to the query vector 220 than the chunk vector 206-2, but chunk vector 202-4 is not desired because the user is searching for the top documents, instead of the top paragraphs in this case.

Other examples of entities can be audio recordings, videos, people of interest, and other entities. For example, a person can have multiple photos, such as from surveillance cameras, which can be considered chunks. A person-of-interest search may want a variety of different people instead of a variety of different photos of the same person. Thus, the people should be matched based on their closest matching photo, or a certain limited number of closest photos, for this search.

In a best match search, a document or other entity is ranked higher if the closest chunk it provides is better than the chunks of other documents. For example, one document may have one chunk that is the closest chunk, but the remaining chunks are farther away from a query vector than chunks of other documents. This document can still be ranked higher based on its closest chunk. There are other variations for ranking top documents, such as ranking documents based on average chunk distances across multiple chunks, using weighting functions for mixing chunk distances, using representative scores for the documents, and other variations for ranking documents or other entities.

### Multi-Vector Query Syntax

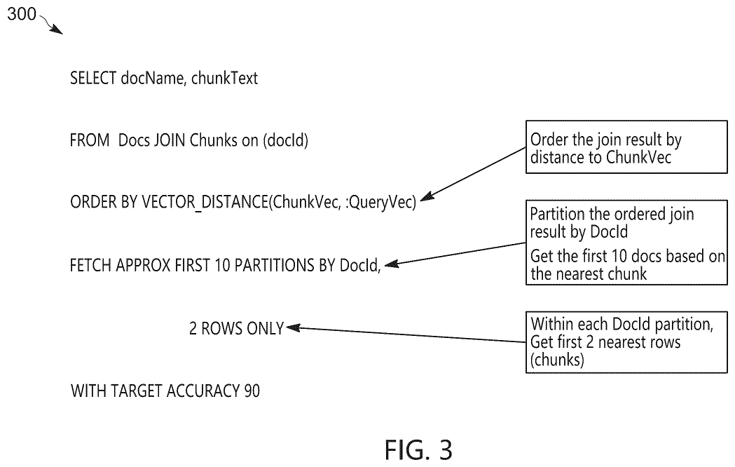

FIG. 3 is an illustration 300 of a multi-vector query syntax according to an example embodiment. In this example, a user desires to find the top 10 documents, docName, containing chunks, such as paragraphs, similar to the query vector, and desires the top two most similar chunks, chunkText, for each document. The documents are joined with the chunks based on a document identifier. The join result is ordered by distance from the chunk vector to the query vector. The ordered join result is partitioned based on the document identifiers. In this application, partitioned means grouped or organized and is not specifically limited to contiguous subsets of rows in a partitioned table. The first 10 documents are fetched based on the nearest chunk. Within each partition of document identifiers, the first two nearest chunks, such as the nearest rows, are fetched. In this example, rows are mentioned along with chunks because the query can also be applied to relational columns, as well as vectors.

The syntax allows a generic hierarchical fetch. The fetch can provide for multiple hierarchical levels. For example, one level in the hierarchy is for paragraphs in a book and another level in the hierarchy is for books by an author. Such a query can request the five most prolific authors that match a search term, and request two books per author, and two paragraphs within each of the books.

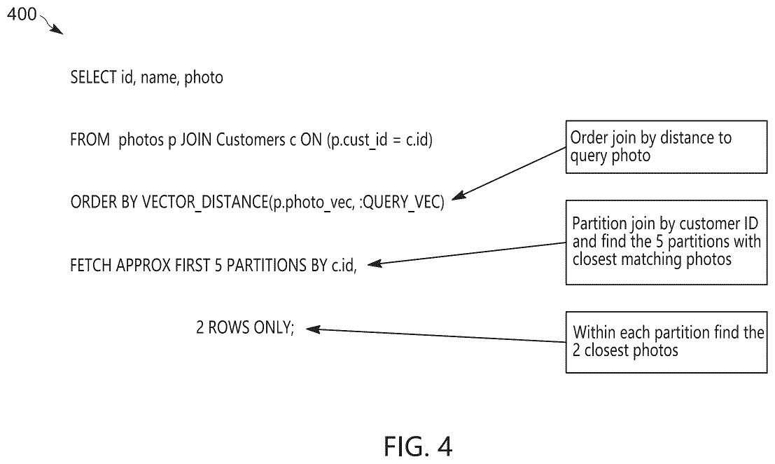

FIG. 4 is an illustration 400 of a query using joins with multi-vector grouping according to an example embodiment. As mentioned above, a multi-vector group by scenario is a scenario in which one entity has multiple vectors. For example, a document may be divided into different chunks, each with a different vector, or a person may have multiple photos, each with a different vector. This example query finds the top five customers and their top two matching photos based on similarity with a search photo. The photos are joined with the customers based on a customer identifier. The join result is ordered by distance from the photo vector to the query photo vector of the search photo. The join is partitioned based on the customer identifier and the top five customers are fetched based on the partitions with the closest matching photos. Within each partition of customers, the first two nearest photos are fetched. This example shows a desired number of partitions, but other implementations may not limit the number of partitions in order to fetch all partitions.

### Hnsw Search

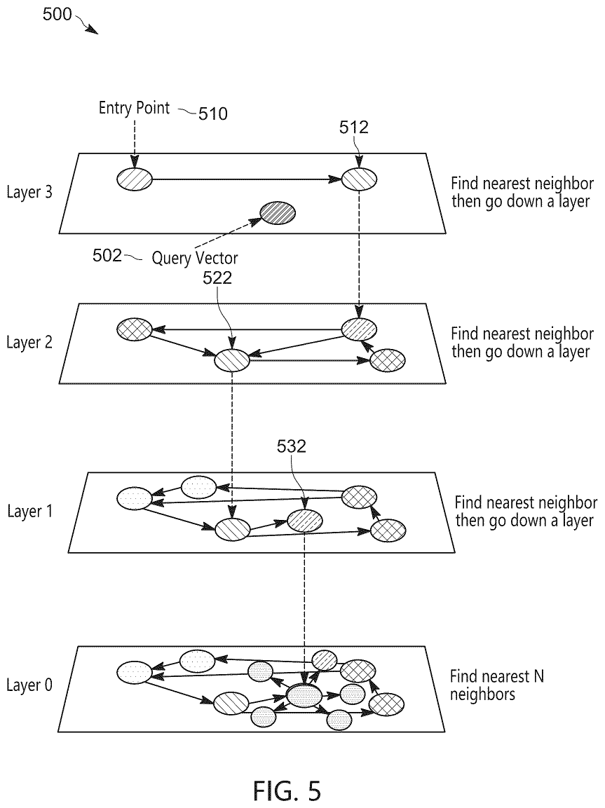

FIG. 5 is a diagram that depicts an example logical representation of an HNSW index 500 that comprises four layers according to an example embodiment. An index search begins from an entry vertex 510 in the top layer (layer 3) and traverses edges looking for the vertex, in that layer, whose vector is nearest query vector 502. If M is 32, then 33 distance calculations are performed between query vector 502 and (i) the vertex of entry vector 510 and (ii) 32 neighbors of entry vector 510. The search process does not only consider neighbors of the entry vector 510, the search process finds the closest neighbor and computes distances for its neighbors as well. This process continues until all the neighbors of a vertex are further from the query vector than the vertex that was used to arrive in that neighborhood. Once the closest vector to query vector 502 in a layer is found (i.e., vertex 512 in this example), the search continues starting with that vertex in the next layer down. This process repeats for each intermediate layer of HNSW index 500. (Thus, vertex 522 is selected in layer 2 and vertex 532 is selected in layer 1.) The index search completes in the lowest layer (i.e., layer 0) by considering the (e.g., 2M) neighbors of vertex 532, in the lowest layer, whose vectors are closest to query vector 502.

For traversing the lowest layer, two heaps are maintained: a candidates heap and a Top K heap. The candidates heap stores vertices that are candidates for further exploration and are ordered based on distance to the query vector. The Top K heap stores the current best Top K result set so far. The Top K heap holds efsearch vertices. The value of efsearch represents the size of a results heap during HNSW traversals and a high number allows more graph exploration to find better results. The search proceeds as follows. Vertex 532 is at the top of the candidates heap and all its 2M neighbors are below it in the candidates heap, ordered by distance to query vector 502. Vertex 532 is selected and compared against all vertices in the Top K heap (which is initially empty). The goal is to check whether a vertex popped from the candidates heap can beat the worst vertex (in terms of distance to the query vector) from the Top K heap (which is also a priority queue ordered in reverse, i.e. furthest vertex among the efsearch vertices is at the top of the Top K heap). If the best candidate vertex beats the worst vertex from the current Top K heap, then the best candidate vertex is added to the to the Top K heap and the worst vertex is removed from the Top K heap. The search continues, meaning more candidates are explored. When vertex 532 is selected, the Top K heap is empty, so vertex 532 is automatically added to the Top K heap.

In a scenario where the Top K heap is full (i.e., it contains efsearch vertices), when a vertex V is selected from the candidates heap, the worst vertex in the Top K heap is replaced by V if V beats that worst vertex. All neighbors of V are then added to candidates heap and ordered within the candidates heap, and the next best vertex in the candidates heap is selected and the search continues. The search terminates if the current best candidate in the candidates heap cannot beat the worst vertex in the Top K heap. Increasing efsearch gives us accuracy because it is more likely for a candidate vertex to be better than the worst vertex in a set of one hundred vertices in the Top K heap than for the candidate vertex to be better than the worst vertex in a set of ten vertices. Thus, with larger values of efsearch, the exploration goes on longer.

### Example Multi-Vector Search

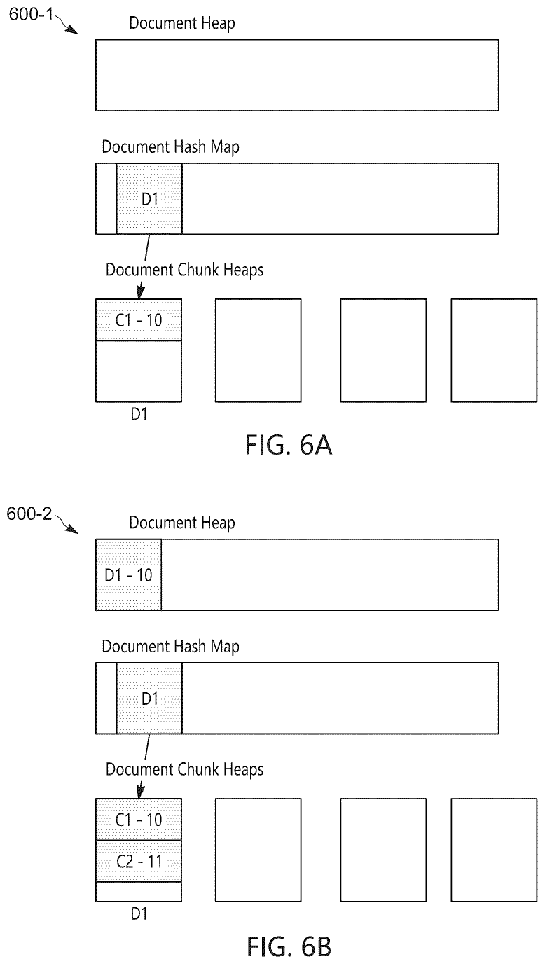

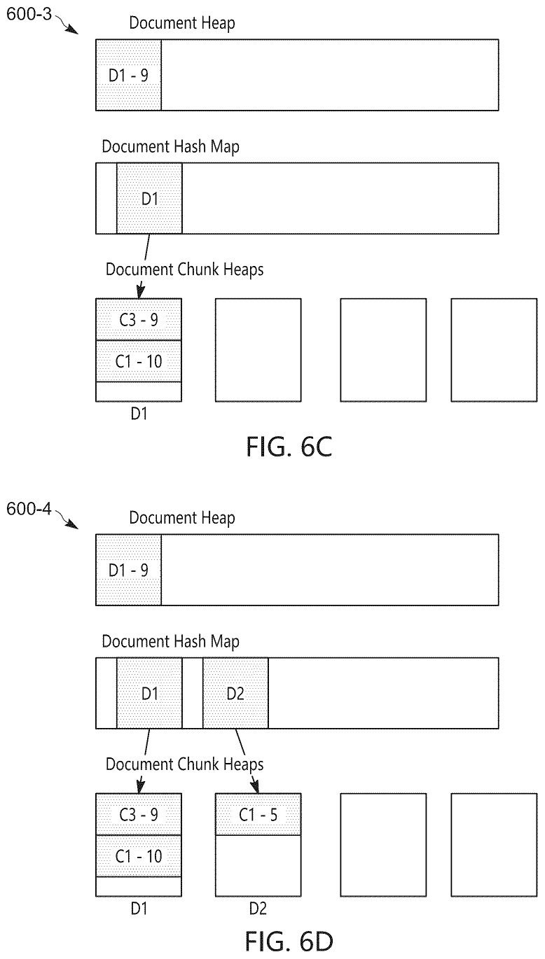

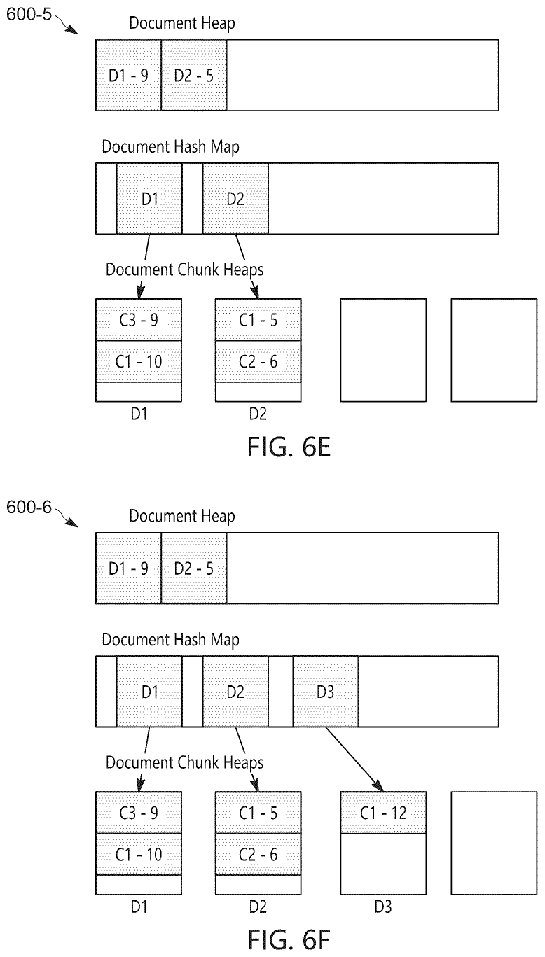

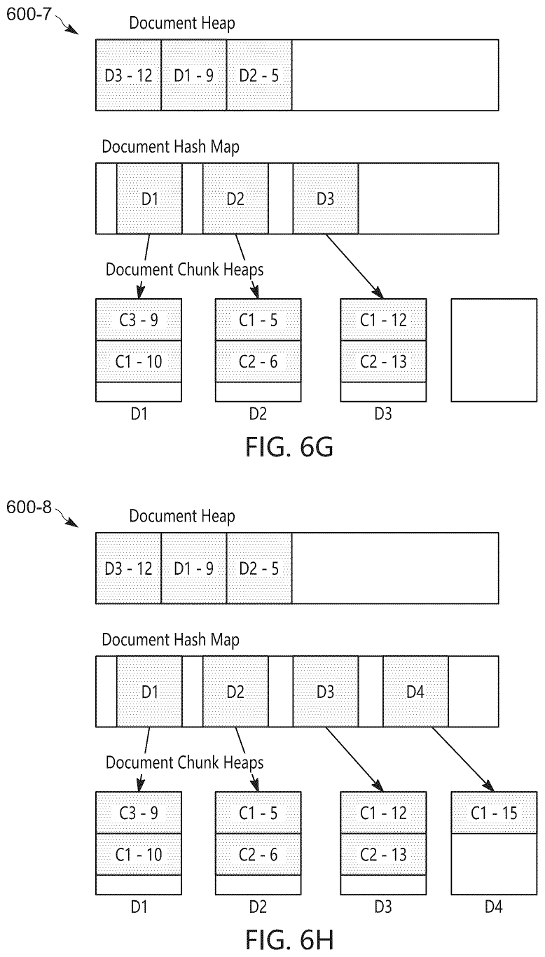

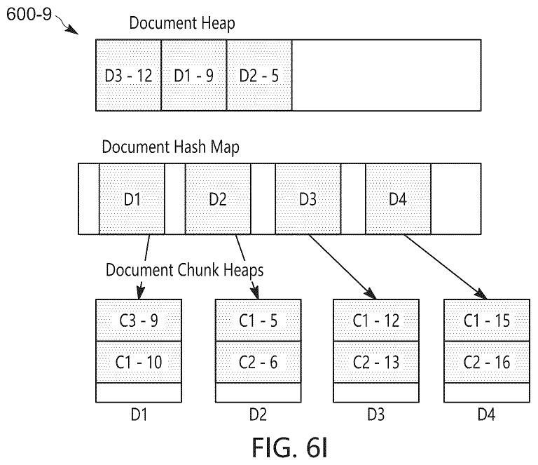

FIGS. 6A through 6I are example illustrations of a process of multi-vector searching according to an example embodiment. The process is broken into operations 600-1 through 600-9, which are collectively referred to as the process 600. The process 600 employs a document heap, a document hash map, and document chunk heaps. The document heap is a results heap and a max heap that is ordered from left to right. The document chunk heaps, also called chunk heaps, are min heaps for each document and include chunks with the minimum distance to a query vector. The document chunk heaps act as an intermediate results heap to the document heap. The document hash map maps each found document to its chunk heap. The exploration heap, such as a candidates heap, is not shown. The two data structures of a chunk heap and a hash map are used in addition to an exploration heap and a results heap.

For this example, a value for the efsearch threshold will be set to 3. The following example query will be employed to describe the process 600:
SELECT docID, chunkID
FROM tab
ORDER BY vector_distance (chunk_vec, :query_vec)
FETCH APPROX FIRST 2 PARTITIONS BY docID WITH 2 ROWS ONLY

The query is asking for the top two docIDs, and the top two rows for each of the docIDs. The desired results are ordered by the vector distance of chunk vectors from the query vector. Rows can be synonymous with chunks. For example, there are multiple chunks for each document in a document table (not shown). The chunks are put into a chunks table (not shown), where every row of the chunks table includes a docID/a chunkID unique pairing.

In this example, the clause “2 ROWS ONLY” is interpreted to mean a document must return at least two rows to qualify for the document heap. The syntax may be different in different applications. For example, in other instances, the clause can be interpreted to mean “up to” 2 rows are requested, where a document that returns one row can qualify for the document heap. Other examples of the syntax can require “at least,” a “minimum of,” “exactly,” and other possible clauses. In this example, if each of the top two docIDs has at least two rows, then this query will return 4 rows, even though APPROX is used.

In operation 600-1, the explored vertex popped from an exploration heap is for chunk 1 of document 1, referred to as document 1, chunk 1 (D1, C1), which has a distance of 10 (dist=10) from the query vector. In the following discussion, references to distance will refer to the distance from the query vector. A chunk heap for D1 is created and C1 with (dist=10) is inserted into the D1 chunk heap. An entry for document D1 is added to the hash map to point to the D1 chunk heap.

Because C1 is a chunk, not a document, C1 is not put into the document heap. Also, because the clause “2 ROWS ONLY” in this example is interpreted to mean a document must return at least two rows to qualify for the document heap, D1 corresponding to chunk (D1, C1) does not yet qualify for the document/results heap. In other instances, D1 may qualify for the document heap, such as when “up to” 2 rows are requested. In all operations, when a chunk is removed from an exploration heap (not shown), its neighbors are added to the exploration heap to explore additional chunks in the HNSW graph in response to a chunk's addition to the chunk heap.

In operation 600-2, the explored vertex is (D1, C2) (dist=11). C2 with (dist=11) is added to the D1 chunk heap. D1 is added to the document heap with the (D1, C1) distance of 10 because that is the smallest distance of C1 and C2 to the query vector.

In operation 600-3, the explored vertex is (D1, C3) (dist=9). C3 is added to the D1 chunk heap and C2 is popped out of the heap because C2 had the highest maximum distance (11) and only two rows/chunks are specified by the “2 ROWS ONLY” clause. To determine the chunk with the maximum distance value in the chunk heap while tracking the chunks with the minimum distance value, the chunk heap can be a min-max heap. If it is only a max heap, the entire heap must be searched to find the minimum distance value. If it is only a min heap, the entire heap must be searched to find and pop the chunk with the maximum value. A min-max heap is a heap that allows finding the element with the minimum value in the heap, as well as popping the element with the maximum value from the heap. It can be considered a min heap with the ability to pop the element with the maximum value. In other words, it allows popping the maximum element and fetching the minimum element. Without the use of a min-max heap, the cost of performing the removal operation of the maximum element on the minimum heap can be on the order of n elements in the heap (O (n)), such as proportional to the number of elements, because all of the elements would be searched to find the maximum element.

The minimum distance value (9) of C3 is obtained from the D1 chunk heap to update the distance value of D1 in the document heap. The previous distance of 10 for D1 in the document heap is updated with the C3 distance of 9 because C3 has the lowest distance. To update the distance value of D1 in the document heap, the D1-10 entry can be deleted, and an entry can added for D1-9 reflecting the distance of 9 for D1. The cost of the operation for deleting the entry, D1-10, can be on the order of n and the cost of inserting the new entry D1-9 can be on the order of log n. For example, to delete the entry, it must be found in the heap, which results in an operational cost of O(n). An optimization can be performed where the document hash map or other hash map maintains a pointer to the D1-9 entry so the entry can be propagated up to make the deletion more like an update with a cost of log n. This optimization may require running a heaping procedure on the heap.

In operation 600-4, the explored vertex is (D2, C1) (dist=5). C1 of document D2 is added to the D2 chunk heap, which may be newly added or allocated to D2 in response to retrieving (D2, C1). An entry for document D2 is added to the hash map to point to the D2 chunk heap. D2 does not yet qualify for the document heap because the D2 chunk heap does not have two chunks.

In operation 600-5, the explored vertex is (D2, C2) (dist=6). C2 is added to the D2 chunk heap. D2 is added to the document heap with a distance of 5, which is the lowest distance in the D2 document chunk heap.

In operation 600-6, the explored vertex is (D3, C1) (dist=12). A document chunk heap is allocated for D3 and C1 is added to the D3 chunk heap. An entry for document D3 is added to the hash map to point to the D3 chunk heap. D3 does not qualify for the document heap because the D3 chunk heap does not have two rows to satisfy the query.

In operation 600-7, the explored vertex is (D3, C2) (dist=13). C2 is added to the D3 chunk heap. D3 is added to the document heap with a distance of 12 because the D3 chunk heap has two rows. At this point, there are three results in the document heap and the distance of D3 is greater than D1 and D2 in the document heap. Without efsearch=3, this would be the condition where the search is stopped because the D3 distance of 12 does not beat the two existing D1 and D2 document distances of 9 and 5, and only two documents are desired with FETCH FIRST 2 PARTITIONS. However, the search is not stopped because efsearch=3. In particular, the search does not stop here, even though the explored chunk (D3, C1) with the minimum distance for D3 has a distance (12) greater than the maximum chunk distance (9) in the document heap. The search does not stop because the number of documents in the document heap has not reached cfsearch=3 when the currently explored vertex has a distance greater than the max chunk distance in the document heap. Now the number of documents has reached efsearch=3, but a document was still able to be inserted into the document heap at this stage, so the search continues.

In operation 600-8, the explored vertex is (D4, C1) (dist=15). C1 is added to the D4 chunk heap. An entry for document D4 is added to the hash map to point to the D4 chunk heap. D4 does not qualify for the document heap because the D4 chunk heap does not have two rows.

In operation 600-9 the explored vertex is (D4, C2) (dist=16). C2 is added to the D4 chunk heap, which qualifies D4 for the document heap based on the number of rows/chunks in the D4 chunk heap. However, the minimum chunk distance of D4 is 15, which is greater than the maximum document distance of 12 in the document heap. At this point the search stops because the minimum distance of the D4 document chunk heap has a distance greater than the maximum distance in the document heap and efsearch=3 has been reached. If the minimum distance of the D4 document chunk heap had been less than the greatest distance of the document heap, the document with the greatest distance would be replaced by D4 and the search would continue until the minimum distance of the currently evaluated document is not less than the greatest document distance in the document heap. In summary, once the number of documents in the document heap reaches efsearch, the search continues until a document cannot be inserted because it does not have a lower distance than an existing document.

### Further Example Multi-Vector Search

In related example embodiment for entities that are documents, data structures for the multi-vector search include a candidates heap. The data structures for the multi-vector search also include a topK document heap that is a max heap that tracks the current topK documents with their min chunks. A query can specify a chunks_per_document value, where only documents for which at least a chunks_per_document value have been explored by the graph search are allowed to be part of the results heap. The data structures for the multi-vector search also include a document hash table that maps documents to their chunk heaps, where each chunk heap tracks the current top chunks_per_document chunks for the document. The data structures for the multi-vector search include chunks heaps for each document. The chunk heaps are min heaps that contain the current top chunks_per_document chunks for the document.

In response to a chunk being popped from the candidates heap, the chunk's neighbor chunks are explored. For each neighbor chunk that gets explored, an explore_chunk( ) routine is called. The neighbor chunk is inserted in the candidates heap if it has not been already visited. The not already visited check can be performed using a visited array.

The document ID of the popped chunk is found by using covering columns, by using a lateral join callback, by referencing a base table, of otherwise determined. The chunk heap for the document ID is found using the document hash table. If the chunk heap for the document is not present, a new chunk heap for the document is created and a pointer to the new chunk heap is added in the document hash table. The chunk is then inserted into the corresponding chunk heap.

If the heap has chunks_per_document+1 chunks in it, the max chunk, the chunk with the largest distance from the query vector, is popped from the heap. The chunk heap can be a min heap, but a min-max heap can be employed for faster removal of the max chunk, otherwise the operation cost will be O(n).

If the chunk heap has chunks_per_document chunks in it, the corresponding document qualifies for insertion into the topK document heap. The minimum chunk, the chunk with the minimum distance from the query vector, is found from this heap and the following operations are performed: A check is performed to determine whether the document is already present in the topK document heap. If the document is present, the document is deleted and the document is reinserted with the distance of the minimum found chunk for the document. If the document heap has more than efsearch elements, the max document is popped from the heap if the current document has a lower minimum distance from the query vector. The deletion process is cost O(n). To make it O(log n), another hash table can be maintained that maps the document ID to a pointer in the topK document heap. The distance value can be updated and the value can be propagated up and down using a heapify procedure.

For every chunk popped from the candidates heap, a check_stopping_condition( ) check is performed. In this check, the distance of the chunk from the query vector is determined. A determination is made as to whether the document chunk heap for this chunk has at least chunks_per_document chunks. If not the search is continued. If the document chunk heap for this chunk does have at least chunks_per_document chunks, and if the topK document heap does not have efsearch elements, the search is continued. If the document chunk heap for this chunk does have at least chunks_per_document chunks and if the topK document heap has efsearch elements, a check is performed as to whether the max chunk of the topK document heap is smaller than the chunk distance. If yes, the search is stopped. Otherwise, the search continues.

At the end, the topK document heap includes a list of efsearch or less number of documents, each with at least chunks_per_document chunks. The max element is popped from the topK_documents_heap and placed into a results heap until the results heap contains top_K documents. Then the documents and chunks are returned in response to the query.

### Example Methods

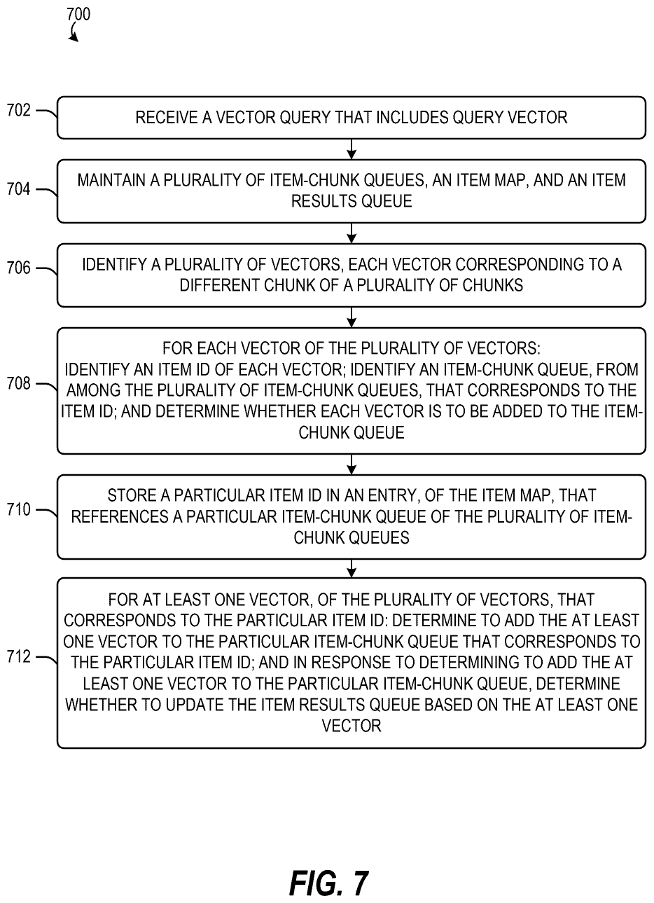

FIG. 7 is a flowchart 700 of a method for multi-vector queries according to an example embodiment. The method is performed by one or more computing devices. At 702, the method includes receiving a vector query that includes a query vector. At 704, the method includes maintaining a plurality of item-chunk queues, such as document chunk heaps, maintaining an item map, such as a document hash map, and maintaining an item results queue, such as a document heap.

While, accessing a HNSW index based on the query vector, at 706, the method includes identifying a plurality of vectors, such as in an exploration/candidates heap, each vector corresponding to a different chunk of a plurality of chunks. At 708, the method includes, for each vector of the plurality of vectors: identifying an item ID of each vector; identifying an item-chunk queue, from among the plurality of item-chunk queues, that corresponds to the item ID; and determining whether each vector is to be added to the item-chunk queue. At 710, the method includes storing a particular item ID in an entry, of the item map, that references a particular item-chunk queue of the plurality of item-chunk queues. At 712, the method includes, for at least one vector, of the plurality of vectors, that corresponds to the particular item ID, determining to add the at least one vector to the particular item-chunk queue that corresponds to the particular item ID; and in response to determining to add the at least one vector to the particular item-chunk queue, determining whether to update the item results queue based on the at least one vector. For example, the item results queue can be updated with the closest vector distance.

According to a possible embodiment, in response to determining to update the item results queue based on the at least one vector, the method includes adding, to the item results queue, an entry that includes the particular item ID and a value that indicates a vector distance between the at least one vector and the query vector. For example, a new document is added to a results heap.

According to a possible embodiment, an existing vector is replaced in a document chunk heap with a vector with a closer distance to the query vector when the number of vectors in the chunk heap exceeds the desired number of rows. For example, determining whether each vector is to be added to the item-chunk queue includes, for a particular vector of each said vector, determining whether a first vector distance between the particular vector and the query vector is less than a second vector distance between a vector in the item-chunk queue and the query vector; determining whether a number of vectors in the item-chunk queue exceeds a threshold value, such as 2 rows only; and replacing an existing vector in the item-chunk queue with the particular vector in response to determining the first vector distance is less than the second vector distance and the number of vectors in the item-chunk queue exceeds the threshold value.

According to a possible embodiment, the method includes determining that the item results queue contains an entry that includes the particular item ID. The method includes, in response to determining to update the item results queue based on the at least one vector and determining that the item results queue contains an entry that includes the particular item ID, replacing, in the entry, a first value, such as an old vector distance between the query vector and another vector associated with the same item ID, with a second value that indicates a vector distance between the at least one vector and the query vector. For example, a vector distance is updated for a document in a results heap.

According to a possible embodiment, the method includes determining that a number of entries in the particular item-chunk queue that corresponds to the particular item ID exceeds a threshold value. The method includes adding an entry corresponding to the particular item ID in the item results queue in response to the number of entries in the particular item-chunk queue exceeding the threshold value. This can correspond to an intermediate stage where an item entry is in the item map but not in an item results heap.

According to a possible embodiment, the method includes storing a second item ID in a second entry, of the item map, that references a second item-chunk queue of the plurality of item-chunk queues, where the item results queue does not include an entry for the second item ID. The method includes, for a second vector, of the plurality of vectors, that corresponds to a second item ID, in response to determining to add the second vector to the second item-chunk queue that corresponds to the second item ID, determining whether to add, to the item results queue, a particular entry for the second item ID. Determining to add, to the item results queue, a particular entry for the second item ID includes performing a comparison between a number of entries in the item results queue with a threshold value, such as efsearch. For example, a value for efsearch can be the basis for a termination condition for adding new documents to a results heap.

According to a possible implementation, the method includes, based on the comparison, determining that the number of entries is equal to the threshold value, such as efsearch. The method includes, in response to determining the number of entries is equal to the threshold value, determining whether the particular entry can replace the one of the entries in the item results queue. For example, a check can be performed to replace an existing document in the results heap if the number of entries in a results heap is the same as efsearch.

According to a possible implementation, the method includes, in response to determining that the particular entry can replace a certain entry in the item results queue, replacing, in the item results queue, the certain entry with the particular entry. According to a possible implementation, the method includes determining that the particular entry cannot replace a certain entry in the item results queue. The method includes, in response to determining the particular entry cannot replace a certain entry in the item results queue and in response to the comparison, determining to cease exploring the HSNW index for additional vectors. For example, the search can be terminated if the number of results in a results heap is equal to efsearch and the new document cannot beat the existing document.

According to a possible embodiment, the method includes allocating a new item-chunk queue for a certain item ID in response to determining that no existing item-chunk queue corresponds to the certain item ID. For example, a document chunk heap can be dynamically created or allocated when a new vector is found for a document that does not yet have a document chunk heap.

According to a possible embodiment, identifying the item ID includes referencing a covering column corresponding to each vector. A vector source array includes a pointer that references covering column storage for each vector.

### Dbms Overview

A database management system (DBMS) manages a database. A DBMS may comprise one or more database servers. A database comprises database data and a database dictionary that are stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically-marked data objects; however, the hierarchically-marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

In a DOCS, a database command may be in the form of functions or object method calls that invoke CRUD (Create Read Update Delete) operations. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snapshot time of the query. The DBMS determines which undo records to apply to a data block based on the respective logical times associated with the undo records.

When operations are referred to herein as being performed at commit time or as being commit time operations, the operations are performed in response to a request to commit a database transaction. DML commands may be auto-committed, that is, are committed in a database session without receiving another command that explicitly requests to begin and/or commit a database transaction. For DML commands that are auto-committed, the request to execute the DML command is also a request to commit the changes made for the DML command.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables and other information.

A database server includes multiple database processes. Database processes run under the control of the database server (i.e. can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g. shared access to a set of disk drives and data blocks stored thereon. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the attribute names and data types of the attributes, and one or more files or portions thereof that store data for the table. Metadata in the database dictionary defining a procedure may specify a name of the procedure, the procedure's arguments and the return data type, and the data types of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e., java file) and the compiled version of the class (i.e., class file).

Native data types are data types supported by a DBMS “out-of-the-box”. Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as a valid data types and to be processed by a DBMS in database statements. In general, database software of a DBMS is programmed to recognize and process native data types without configuring the DBMS to do so by, for example, defining a data type by issuing DDL statements to the DBMS.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

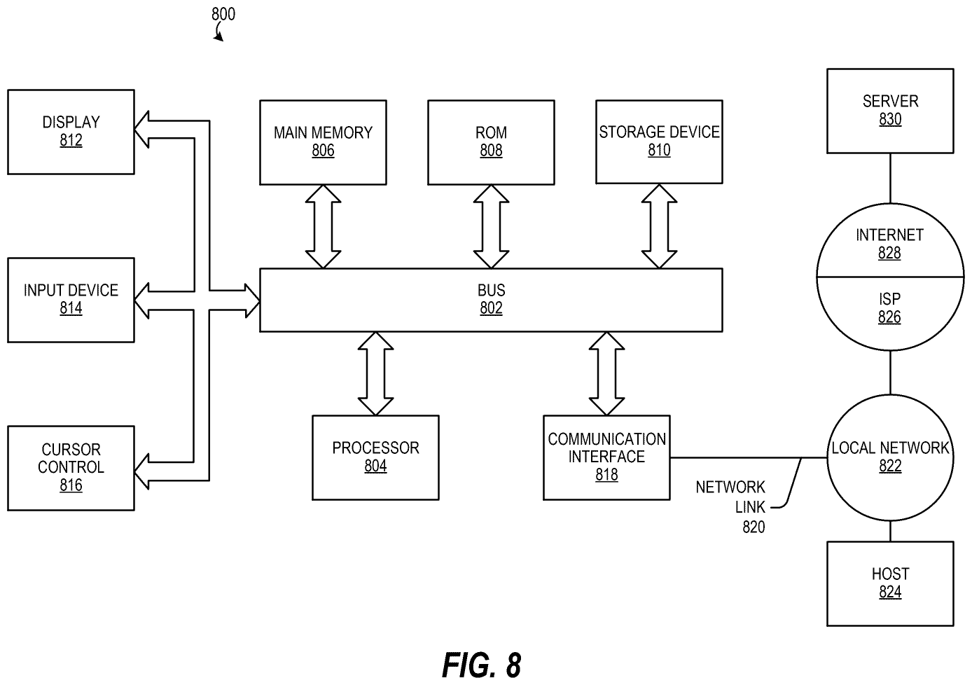

For example, FIG. 8 is a block diagram that illustrates a computer system 800 upon which aspects of the illustrative embodiments may be implemented. Computer system 800 includes a bus 802 or other communication mechanism for communicating information, and a hardware processor 804 coupled with bus 802 for processing information. Hardware processor 804 may be, for example, a general-purpose microprocessor.

Computer system 800 also includes a main memory 806, such as a random-access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or solid-state drive is provided and coupled to bus 802 for storing information and instructions.

Computer system 800 may be coupled via bus 802 to a display 812 for displaying information to a computer user. An input device 814, including alphanumeric and other keys, is coupled to bus 802 for communicating information and command selections to processor 804. Another type of user input device is cursor control 816, such as a mouse, a trackball, a touch screen, a track pad, and/or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 810. Volatile media includes dynamic memory, such as main memory 806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and/or any other storage media.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem or send the instructions using a network. A receiver, such as a modem, local to computer system 800 can receive the data and use, for an example, an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented, such as to a wireless local area network (WLAN) or to a cellular network. In any such implementation, communication interface 818 sends and receives electrical, electromagnetic, radio, optical, and/or other signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world-wide packet data communication network now commonly referred to as the “Internet” 828. Local network 822 and Internet 828 both use electrical, electromagnetic, or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### Software Over View

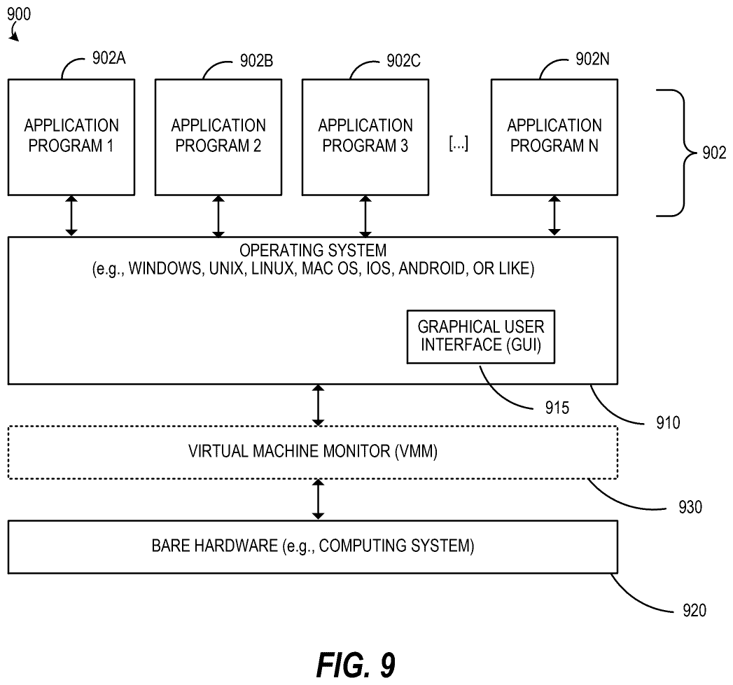

FIG. 9 is a block diagram of a basic software system 900 that may be employed for controlling the operation of computer system 800. Software system 900 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 900 is provided for directing the operation of computer system 800. Software system 900, which may be stored in system memory (RAM) 806 and on fixed storage (e.g., hard disk or flash memory) 810, includes a kernel or operating system (OS) 910.

The OS 910 manages low-level aspects of computer operation, including managing execution of processes, memory allocation, file input and output (I/O), and device I/O. One or more application programs, represented as 902A, 902B, 902C . . . 902N, may be “loaded” (e.g., transferred from fixed storage 810 into memory 806) for execution by the system 900. The applications or other software intended for use on computer system 800 may also be stored as a set of downloadable computer-executable instructions, for example, for downloading and installation from an Internet location (e.g., a Web server, an app store, or other online service).

Software system 900 includes a graphical user interface (GUI) 915, for receiving user commands and data in a graphical (e.g., “point-and-click” or “touch gesture”) fashion. These inputs, in turn, may be acted upon by the system 900 in accordance with instructions from operating system 910 and/or application(s) 902. The GUI 915 also serves to display the results of operation from the OS 910 and application(s) 902, whereupon the user may supply additional inputs or terminate the session (e.g., log off).

OS 910 can execute directly on the bare hardware 920 (e.g., processor(s) 804) of computer system 800. Alternatively, a hypervisor or virtual machine monitor (VMM) 930 may be interposed between the bare hardware 920 and the OS 910. In this configuration, VMM 930 acts as a software “cushion” or virtualization layer between the OS 910 and the bare hardware 920 of the computer system 800.

VMM 930 instantiates and runs one or more virtual machine instances (“guest machines”). Each guest machine comprises a “guest” operating system, such as OS 910, and one or more applications, such as application(s) 902, designed to execute on the guest operating system. The VMM 930 presents the guest operating systems with a virtual operating platform and manages the execution of the guest operating systems.

In some instances, the VMM 930 may allow a guest operating system to run as if it is running on the bare hardware 920 of computer system 800 directly. In these instances, the same version of the guest operating system configured to execute on the bare hardware 920 directly may also execute on VMM 930 without modification or reconfiguration. In other words, VMM 930 may provide full hardware and CPU virtualization to a guest operating system in some instances.

In other instances, a guest operating system may be specially designed or configured to execute on VMM 930 for efficiency. In these instances, the guest operating system is “aware” that it executes on a virtual machine monitor. In other words, VMM 930 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving a vector query that includes a query vector;
maintaining a plurality of item-chunk queues, an item map, and an item results queue; and
while accessing a Hierarchical Navigable Small Worlds (HNSW) index based on the query vector:
identifying a plurality of vectors, each vector corresponding to a different chunk of a plurality of chunks;
for each vector of the plurality of vectors:
identifying an item identifier (ID) of said each vector;
identifying an item-chunk queue, from among the plurality of item-chunk queues, that corresponds to the item ID; and
determining whether said each vector is to be added to the item-chunk queue;
storing a particular item ID in an entry, of the item map, that references a particular item-chunk queue of the plurality of item-chunk queues; and
for at least one vector, of the plurality of vectors, that corresponds to the particular item ID,
determining to add the at least one vector to the particular item-chunk queue that corresponds to the particular item ID; and
in response to determining to add the at least one vector to the particular item-chunk queue, determining whether to update the item results queue based on the at least one vector;
wherein the method is performed by one or more computing devices.

2. The method of claim 1, further comprising:
in response to determining to update the item results queue based on the at least one vector, adding, to the item results queue, an entry that includes the particular item ID and a value that indicates a vector distance between the at least one vector and the query vector.

3. The method of claim 1, wherein determining whether said each vector is to be added to the item-chunk queue comprises for a particular vector of each said vector,
determining whether a first vector distance between the particular vector and the query vector is less than a second vector distance between a vector in the item-chunk queue and the query vector;
determining whether a number of vectors in the item-chunk queue exceeds a threshold value; and
replacing an existing vector in the item-chunk queue with the particular vector in response to determining the first vector distance is less than the second vector distance and the number of vectors in the item-chunk queue exceeds the threshold value.

4. The method of claim 1, further comprising:
determining that the item results queue contains an entry that includes the particular item ID; and
in response to determining to update the item results queue based on the at least one vector and determining that the item results queue contains an entry that includes the particular item ID, replacing, in the entry, a first value with a second value that indicates a vector distance between the at least one vector and the query vector.

5. The method of claim 1, further comprising:
determining that a number of entries in the particular item-chunk queue that corresponds to the particular item ID exceeds a threshold value; and
adding an entry corresponding to the particular item ID in the item results queue in response to the number of entries in the particular item-chunk queue exceeding the threshold value.

6. The method of claim 1, further comprising:
storing a second item ID in a second entry, of the item map, that references a second item-chunk queue of the plurality of item-chunk queues;
wherein the item results queue does not include an entry for the second item ID;
for a second vector, of the plurality of vectors, that corresponds to a second item ID, in response to determining to add the second vector to the second item-chunk queue that corresponds to the second item ID, determining whether to add, to the item results queue, a particular entry for the second item ID;
wherein determining to add, to the item results queue, a particular entry for the second item ID comprises performing a comparison between a number of entries in the item results queue with a threshold value.

7. The method of claim 6, further comprising:
based on the comparison, determining that the number of entries is equal to the threshold value; and
in response to determining the number of entries is equal to the threshold value, determining whether the particular entry can replace the one of the entries in the item results queue.

8. The method of claim 7, further comprising:
in response to determining that the particular entry can replace a certain entry in the item results queue, replacing, in the item results queue, the certain entry with the particular entry.

9. The method of claim 7, further comprising:
determining that the particular entry cannot replace a certain entry in the item results queue; and
in response to determining the particular entry cannot replace a certain entry in the item results queue and in response to the comparison, determining to cease exploring the HSNW index for additional vectors.

10. The method of claim 1, further comprising allocating a new item-chunk queue for a certain item ID in response to determining no existing item-chunk queue corresponds to the certain item ID.

11. The method of claim 1, wherein identifying the item ID comprises referencing a covering column corresponding to each vector, wherein a vector source array includes a pointer that references covering column storage for each vector.

12. One or more non-transitory storage media storing one or more sequences of instructions which, when executed by one or more computing devices, cause:
receiving a vector query that includes a query vector;
maintaining a plurality of item-chunk queues, an item map, and an item results queue; and
while accessing a Hierarchical Navigable Small Worlds (HNSW) index based on the query vector:
identifying a plurality of vectors, each vector corresponding to a different chunk of a plurality of chunks;
for each vector of the plurality of vectors:
identifying an item identifier (ID) of said each vector;
identifying an item-chunk queue, from among the plurality of item-chunk queues, that corresponds to the item ID; and
determining whether said each vector is to be added to the item-chunk queue;
storing a particular item ID in an entry, of the item map, that references a particular item-chunk queue of the plurality of item-chunk queues; and
for at least one vector, of the plurality of vectors, that corresponds to the particular item ID,
determining to add the at least one vector to the particular item-chunk queue that corresponds to the particular item ID; and
in response to determining to add the at least one vector to the particular item-chunk queue, determining whether to update the item results queue based on the at least one vector;
wherein the method is performed by one or more computing devices.

13. The one or more non-transitory storage media of claim 12, wherein the instructions, when executed by the one or more computing devices, further cause:
in response to determining to update the item results queue based on the at least one vector, adding, to the item results queue, an entry that includes the particular item ID and a value that indicates a vector distance between the at least one vector and the query vector.

14. The one or more non-transitory storage media of claim 12, wherein determining whether said each vector is to be added to the item-chunk queue comprises for a particular vector of each said vector,
determining whether a first vector distance between the particular vector and the query vector is less than a second vector distance between a vector in the item-chunk queue and the query vector;
determining whether a number of vectors in the item-chunk queue exceeds a threshold value; and
replacing an existing vector in the item-chunk queue with the particular vector in response to determining the first vector distance is less than the second vector distance and the number of vectors in the item-chunk queue exceeds the threshold value.

15. The one or more non-transitory storage media of claim 12, wherein the instructions, when executed by the one or more computing devices, further cause:
determining that the item results queue contains an entry that includes the particular item ID; and
in response to determining to update the item results queue based on the at least one vector and determining that the item results queue contains an entry that includes the particular item ID, replacing, in the entry, a first value with a second value that indicates a vector distance between the at least one vector and the query vector.

16. The one or more non-transitory storage media of claim 12, wherein the instructions, when executed by the one or more computing devices, further cause:
determining that a number of entries in the particular item-chunk queue that corresponds to the particular item ID exceeds a threshold value; and
adding an entry corresponding to the particular item ID in the item results queue in response to the number of entries in the particular item-chunk queue exceeding the threshold value.

17. The one or more non-transitory storage media of claim 12, wherein the instructions, when executed by the one or more computing devices, further cause:
storing a second item ID in a second entry, of the item map, that references a second item-chunk queue of the plurality of item-chunk queues;
wherein the item results queue does not include an entry for the second item ID;
for a second vector, of the plurality of vectors, that corresponds to a second item ID, in response to determining to add the second vector to the second item-chunk queue that corresponds to the second item ID, determining whether to add, to the item results queue, a particular entry for the second item ID;
wherein determining to add, to the item results queue, a particular entry for the second item ID comprises performing a comparison between a number of entries in the item results queue with a threshold value.

18. The one or more non-transitory storage media of claim 17, wherein the instructions, when executed by the one or more computing devices, further cause:
based on the comparison, determining that the number of entries is equal to the threshold value; and
in response to determining the number of entries is equal to the threshold value, determining whether the particular entry can replace the one of the entries in the item results queue.

19. The one or more non-transitory storage media of claim 12, wherein the instructions, when executed by the one or more computing devices, further cause allocating a new item-chunk queue for a certain item ID in response to determining no existing item-chunk queue corresponds to the certain item ID.

20. The one or more non-transitory storage media of claim 12, wherein identifying the item ID comprises referencing a covering column corresponding to each vector, wherein a vector source array includes a pointer that references covering column storage for each vector.
